(19) United States
(12) Patent Application Publication
(10) Pub. No.: US 2016/0121420 A1
(43) Pub. Date: May 5, 2016

(54) SYSTEM AND METHOD FOR MEASURING ROTATION OF A WIRE FEED MECHANISM

(71) Applicant: ILLINOIS TOOL WORKS INC., Glenview, IL (US)

(72) Inventor: Marc Lee Denis, Lena, WI (US)

(21) Appl. No.: 14/531,664

(22) Filed: Nov. 3, 2014

(51) Int. Cl. B23K 9/12; G01P 3/489

(52) U.S. Cl. CPC B23K 9/124; G01P 3/489

(57) ABSTRACT

A feed roller rotation measurement system includes a voltage tuned oscillator (VTO) having a capacitor and an inductor coupled to each other. The VTO is configured to be disposed adjacent a shaped feature formed in a surface of a feed roller of a wire feeder. The feed roller rotation measurement system also includes a phase locked loop (PLL) controller electrically coupled to the VTO and configured to determine and send a correction voltage to the VTO to maintain the VTO at a desired oscillating frequency. The feed roller rotation measurement system further includes a processor coupled to the PLL controller and configured to receive a signal from the PLL controller indicative of the correction voltage and to calculate a speed of rotation of the feed roller based at least in part on the received signal.

### BACKGROUND

The disclosure relates generally to welding systems and, more particularly, to a system for measuring rotation of a wire feed mechanism in a welding wire feeder.

Welding is a process that has increasingly become ubiquitous in various industries and applications. While such processes may be automated in certain contexts, a large number of applications continue to exist for manual welding operations. Such welding operations rely on a variety of types of equipment to ensure the supply of welding consumables (e.g., wire feed, shielding gas, etc.) is provided to the weld in an appropriate amount at a desired time. For example, gas metal arc welding (GMAW) typically relies on a wire feeder to ensure a proper wire feed reaches a welding torch.

Such wire feeders facilitate the feeding of welding wire from a wire spool, through a pair of feed rollers, to the welding torch at a desired wire feed rate. At least one of the feed rollers, a drive roller, is driven by a motor to move the welding wire through the wire feeder. Some wire feeders are equipped with systems designed to measure the rotation of the feed rollers, in order to detect a linear speed of the wire being output from the wire feeder. However, these existing measurement systems often include expensive optical assemblies that utilize relatively large amounts of power, and are difficult to operate in dusty or contaminated environments.

### BRIEF DESCRIPTION

In an embodiment, a feed roller rotation measurement system includes a voltage tuned oscillator (VTO) having a capacitor and an inductor coupled to each other. The VTO is configured to be disposed adjacent a shaped feature formed in a surface of a feed roller of a wire feeder. The feed roller rotation measurement system also includes a phase locked loop (PLL) controller electrically coupled to the VTO and configured to determine and send a correction voltage to the VTO to maintain the VTO at a desired oscillating frequency. The feed roller rotation measurement system further includes a processor coupled to the PLL controller and configured to receive a signal from the PLL controller indicative of the correction voltage and to calculate a speed of rotation of the feed roller based at least in part on the received signal.

In another embodiment, a wire feeder includes a feed roller configured to rotate with respect to a housing of the wire feeder. The feed roller includes a shaped feature formed into a surface of the feed roller. The wire feeder also includes a first frequency oscillator disposed adjacent the surface of the feed roller. The first frequency oscillator comprises a capacitor and an inductor coupled to each other. The wire feeder further includes a controller electrically coupled to the first frequency oscillator and configured to determine and send a correction voltage to the first frequency oscillator to maintain the first frequency oscillator at a desired oscillating frequency. In addition, the wire feeder includes a processor coupled to the controller and configured to receive a signal from the controller indicative of the correction voltage and to calculate a speed of rotation of the feed roller based at least in part on the received signal.

In a further embodiment, a method includes rotating a feed roller of a wire feeder with respect to a wire feeder housing to move a welding wire through the wire feeder. The feed roller includes at least one shaped feature formed into a surface of the feed roller. The method also includes maintaining a frequency of a voltage tuned oscillator (VTO) disposed adjacent the feed roller based on a correction voltage determined by a phase locked loop (PLL) controller coupled to the VTO based at least in part on motion of the at least one shaped feature of the feed roller with respect to the VTO. In addition, the method includes calculating a speed of rotation of the feed roller based at least in part on the correction voltage via a processor coupled to the PLL controller.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic representation of a welding system utilizing a wire feeder that may include a roller rotation measurement system, in accordance with an embodiment of the present disclosure;

FIG. 2 is a schematic block diagram of certain components of the wire feeder of FIG. 1, in accordance with an embodiment of the present disclosure;

FIG. 3 is a schematic block diagram of a roller rotation measurement system that may be used in the wire feeder of FIG. 2, in accordance with an embodiment of the present disclosure;

FIG. 4 is a schematic top view of certain components of the wire feeder of FIG. 2, in accordance with an embodiment of the present disclosure;

FIG. 5 is a schematic block diagram of a roller rotation measurement system that may be used in the wire feeder of FIG. 2, in accordance with an embodiment of the present disclosure;

FIG. 6 is a schematic block diagram of a roller rotation measurement system with that may be used for quadrature detection in the wire feeder of FIG. 2, in accordance with an embodiment of the present disclosure;

FIG. 7 is a side view of a feed roller that may be used in the roller rotation measurement systems of FIGS. 2-5, in accordance with an embodiment of the present disclosure;

FIG. 8 is a process flow diagram of a method for operating the roller rotation measurement systems of FIGS. 2-5, in accordance with an embodiment of the present disclosure;

FIG. 9 is a schematic block diagram of another roller rotation measurement system that may be used in the wire feeder of FIG. 2, in accordance with an embodiment of the present disclosure;

FIG. 10 is a schematic block diagram of another roller rotation measurement system that may be used in the wire feeder of FIG. 2, in accordance with an embodiment of the present disclosure; and

FIG. 11 is a process flow diagram of a method for operating the roller rotation measurement system of FIG. 10, in accordance with an embodiment of the present disclosure.

### DETAILED DESCRIPTION

Presently disclosed embodiments are directed to systems and methods for detecting a wire feed speed of wire coming out of a welding wire feeder by measuring a rotation of one or more feed rollers in the wire feeder. In some existing wire feed speed detection systems, a detection component touches one or more of the welding wire or the feed rollers used to push the welding wire through the wire feeder. However, this can lead to undesirable slowing of the wire feeder and cumbersome set up of the wire feeder. In other existing wire feed speed detection systems, optical sensing devices are used to detect markings on a feed roller without touching the feed roller. Such optical systems generally operate well within clean environments, but the presence of dust or other contaminants can decrease the clarity of sensing the markings, leading to inaccurate measurements. In addition, these optical systems typically do not have long lives, since they have relatively high power requirements for powering LEDs to provide light for the detection. The optical systems sometimes are configured to provide quadrature detection, in order to determine both the speed and direction of rotation of the feed rollers. However, such optical quadrature assemblies are relatively expensive to manufacture and assemble into wire feeders.

Accordingly, it is now recognized that there is a need for roller rotation measurement systems that overcome these drawbacks. Presently disclosed embodiments are designed to address these needs, as described in detail below. The presently disclosed embodiments include systems and methods for measuring rotation of one or more feed rollers in the wire feeder. Specifically, a wire feeder may be equipped with a roller rotation measurement system that uses a voltage tuned oscillator (VTO) and phase locked loop (PLL) controller to determine the speed of rotation of the one or more feed rollers. A corresponding feed roller may be manufactured with dimples or bumps that extend in a direction of the VTO when the feed roller is installed in the wire feeder. An inductance or capacitance of the VTO circuit is affected by the presence of each dimple or bump in the feed roller as the feed roller rotates. The PLL controller may send a correction signal to the VTO to correct for the disturbance in inductance or capacitance, and the PLL controller may send a signal to a second controller that is indicative of the correction signal sent to the VTO. The second controller then may calculate the linear speed of welding wire moving through the feed roller, based on the number of disturbances detected over a given time, the number of dimples or bumps on the feed roller, and a radius of the feed roller.

Presently disclosed measurement systems and methods allow for a relatively inexpensive roller rotation measurement system that can be installed in a wire feeder. The roller rotation measurement system may run on less power than existing optical systems, since no LEDs are involved, while still allowing for quadrature detection. Further, the disclosed roller rotation measurement system is operable in environments that are dirty as well as clean, since the detection does not depend on optical measurements. Still further, the disclosed systems do not contact the feed rollers or the welding wire being moved through the wire feeder, thus maintaining relatively accurate measurements of the feed roller rotation and, subsequently, of the wire feed speed.

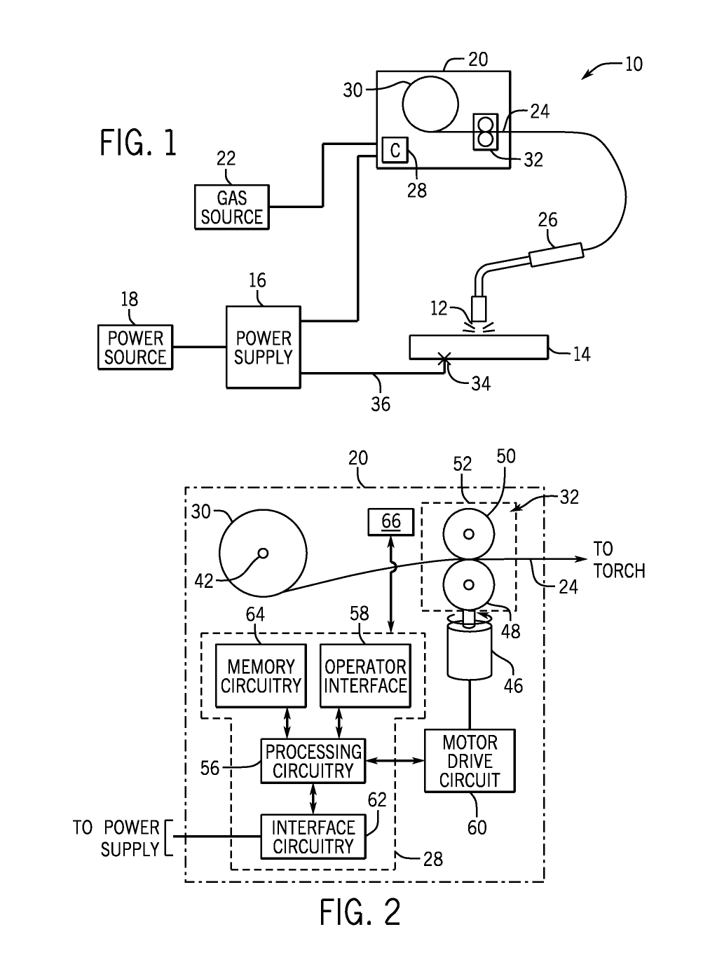

Turning now to the drawings, FIG. 1 is a schematic representation of an embodiment of a welding system 10 that may include roller rotation measurement system in accordance with present techniques. The welding system 10 is designed to produce a welding arc 12 on a work piece 14. The welding arc 12 may be of any type of weld, and may be oriented in any desired manner, including metal inert gas (MIG), metal active gas (MAG), various waveforms, tandem setup, and so forth. The welding system 10 includes a power supply 16 that will typically be coupled to a power source 18, such as a power grid. Other power sources may, of course, be utilized including generators, engine-driven power packs, and so forth. In the illustrated embodiment, a wire feeder 20 is coupled to a gas source 22 and the power supply 16, and supplies welding wire 24 to a welding torch 26. The welding wire 24 is fed through the welding torch 26 and is used to establish the welding arc 12 deposited on the work piece 14.

The wire feeder 20 will typically include control circuitry 28, which regulates the feed of the welding wire 24 from a spool 30, and commands the output of the power supply 16. The spool 30 will contain a length of welding wire 24 that is consumed during the welding operation. The welding wire 24 is advanced by a wire drive assembly 32, typically through the use of an electric motor under control of the control circuitry 28. The wire drive assembly 32 may utilize a roller rotation measurement system to detect a speed of rotating feed rollers used to move the welding wire 24 through the wire feeder 20. The work piece 14 is coupled to the power supply 16 by a clamp 34 connected to a work cable 36 to complete an electrical circuit when the welding arc 12 is established between the welding torch 26 and the work piece 14.

Placement of the welding torch 26 at a location proximate to the work piece 14 allows electrical current, which is provided by the power supply 16 and routed to the welding torch 26, to arc from the welding torch 26 to the work piece 14. As described above, this arcing completes an electrical circuit that includes the power supply 16, the welding torch 26, the work piece 14, and the work cable 36. Particularly, in operation, electrical current passes from the power supply 16, to the welding torch 26, to the work piece 14, which is typically connected back to the power supply 16 via the work cable 36. The arcing generates a relatively large amount of heat that causes part of the work piece 14 and the filler metal of the welding wire 24 to transition to a molten state, thereby forming the weld.

To shield the weld area from being oxidized or contaminated during welding, to enhance arc performance, and to improve the resulting weld, the welding system 10 also feeds an inert shielding gas to the welding torch 26 from the gas source 22. It is worth noting, however, that a variety of shielding materials for protecting the weld location may be employed in addition to, or in place of, the inert shielding gas, including active gases and particulate solids.

FIG. 2 is a block diagram of an embodiment of certain components of the wire feeder 20 of FIG. 1. In certain embodiments, the welding wire 24 is supplied from the spool 30, which may be mounted via a spool mount 42 within the wire feeder 20. The wire drive assembly 32 facilitates progressive feeding of the welding wire 24 from the spool 30 to the welding torch 26 at a desired rate for the welding application. A motor 46 is provided that engages with two feed rollers 48 and 50 to push the welding wire 24 from the wire feeder 20 toward the welding torch 26. In practice, one of the feed rollers (i.e., a drive roller) 48 is mechanically coupled to the motor 46 and is rotated by the motor 46 to drive the welding wire 24 from the wire feeder 20, while the mating feed roller (i.e., an idler roller) 50 is biased toward the drive roller 48 to maintain contact between the two feed rollers 48 and 50 and the welding wire 24. The feed rollers 48 and 50 may be supported on a wire drive assembly housing 52 of the wire feeder 20. Both the drive roller 48 and the idler roller 50 are configured to rotate with respect to the wire drive assembly housing 52. The illustrated embodiment shows one pair of feed rollers 48 and 50, although the wire feeder 20 may include multiple pairs of such feed rollers in certain embodiments.

In addition to mechanical components, the wire feeder 20 also includes the control circuitry 28 for controlling the wire feed speed of the welding wire 24 through the wire feeder 20, among other things. In certain embodiments, processing circuitry 56 is coupled to an operator interface 58 on the wire feeder 20 that allows selection of one or more welding parameters, for example, wire feed speed. The operator interface 58 may also allow for selection of welding parameters such as the welding process, the type of welding wire 24 utilized, current, voltage or power settings, and so forth. The processing circuitry 56 communicates with the motor 46 via a motor drive circuit 60, allowing control of wire feed speeds in accordance with operator selections. Additionally, the processing circuitry 56 permits these settings to be sent back to the power supply 16 via interface circuitry 62 and/or stored by appropriate memory circuitry 64 for later use. The control circuitry 28 within the wire feeder 20 may also regulate the flow of shielding gas from the gas source 22 to the welding torch 26. In general, such shielding gas is provided at the time of welding, and may be turned on immediately preceding welding and for a short time following welding.

In presently disclosed embodiments, the wire feeder 20 includes a roller rotation measurement system 66 configured to provide feedback relating to the wire feed speed of the wire feeder 20 to the control circuitry 28. Specifically, the roller rotation measurement system 66 measures the rotation of one or more of the feed rollers 48 and 50 and provides a signal to the control circuitry 28 indicative of the rotational speed, or the linear wire feed speed, of the wire feeder 20 based on this measured rotation. In certain embodiments, the roller rotation measurement system 66 uses a voltage tuned oscillator (VTO) and phase locked loop (PLL) controller to detect features that are manufactured into one of the feed rollers 48 and 50. In the illustrated embodiment, for example, the roller rotation measurement system 66 is disposed adjacent (e.g., proximate to, for example, within 1/1000^{th} of an inch in certain embodiments) to the idler roller 50 to detect features present on a face of the rotating idler roller 50. The processing circuitry 56 may calculate a linear wire feed speed of the wire 24 moving through the wire feeder 20 based on the frequency of the detected features of the idler roller 50 passing the roller rotational measurement system 66. The processing circuitry 56 then may make adjustments to control signals provided to the motor drive circuit 60 based on the measured wire feed speed, to facilitate feeding of the welding wire 24 at the desired feed speed selected by an operator. Although illustrated in FIG. 2 as being disposed adjacent to the idler roller 50 to detect features present on a face of the rotating idler roller 50, in other embodiments, the roller rotation measurement system 66 may be disposed adjacent to the drive roller 48 to detect features present on a face of the rotating drive roller 48.

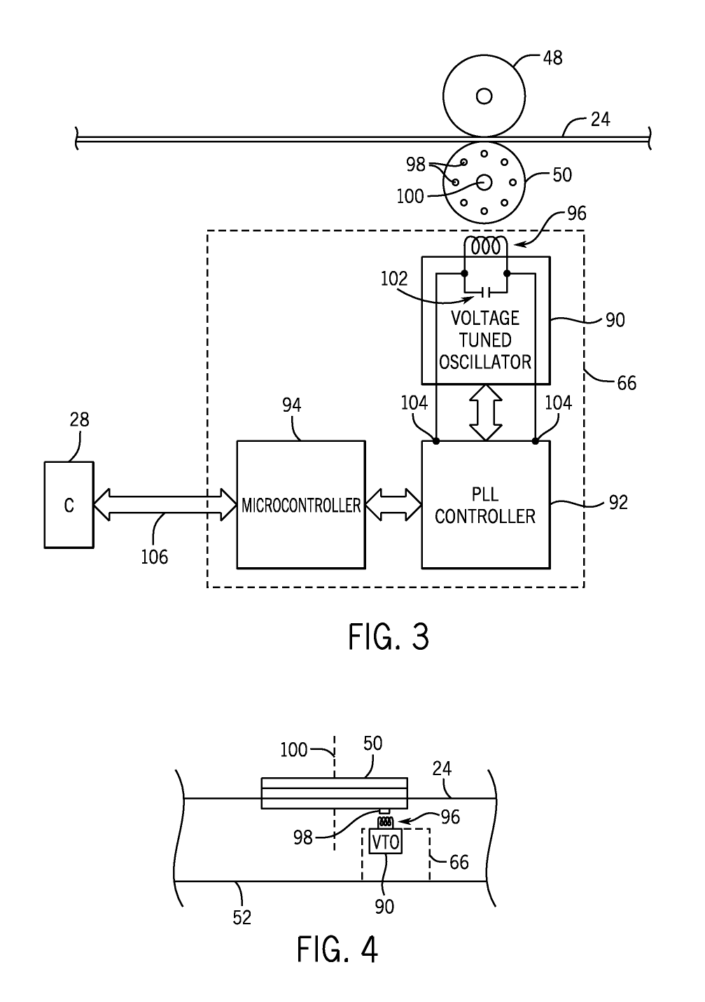

FIG. 3 is a more detailed schematic illustration of certain components of the wire feeder 20, particularly focusing on the roller rotation measurement system 66. As noted above, the roller rotation measurement system 66 may include a voltage tuned oscillator (VTO) 90, a phase-locked loop (PLL) controller 92, and a microcontroller 94 (or some other controller mechanism used to calculate wire feed speed). The illustrated VTO 90 includes an inductor 96 that extends outward toward the idler roller 50. It should be noted that no part of the roller rotation measurement system 66 is in contact with either of the feed rollers 48 and 50 or the welding wire 24. This may help the disclosed roller rotation measurement system 66 last longer than other types of wire feed speed measurement systems that include components placed in direct contact with the rotating machinery.

As mentioned above, the feed roller 50 includes a number of shaped features 98 formed into the surface of a face of the feed roller 50. These shaped features 98 may, in some embodiments, include protuberances, bumps, dimples, divots, small pockets, or holes. These shaped features 98 may take any desirable shape. In some embodiments, the shaped features 98 may each include groupings of several such protuberances, bumps, dimples, divots, small pockets, or holes. These shaped features 98 may be machined into the feed roller 50 during a manufacturing process (e.g., drilling process). As illustrated, the shaped features 98 may be arranged radially about the face of the feed roller 50 facing the VTO 90. More specifically, each of the shaped features 98 may be formed at approximately the same radial distance from a centerline 100 of the feed roller 50. In certain embodiments, the angles formed between adjacent shaped features 98 may be consistent around the entire feed roller 50. While eight shaped features 98 are illustrated on the feed roller 50 of FIG. 3, other embodiments of the feed roller 50 may include different numbers of shaped features 98 (e.g., 1, 2, 3, 4, 5, 6, 7, 9, 10, or more) arranged radially about the face of the feed roller 50. In the illustrated embodiment, the shaped features 98 are illustrated on a single side of the feed roller 50. It should be noted that in some embodiments, both faces of the feed roller 50 may include such shaped features 50 to aid in wire feed speed detection.

In the illustrated embodiment, the shaped features 98 are located on the idler feed roller 50 and not on the drive feed roller 48. It should be noted that, in other embodiments, this arrangement may be reversed so that the shaped features 98 are formed onto the driver feed roller 48 and not on the idler feed roller 50. It may be desirable in some instances for the shaped features 98 to be on the idler feed roller 50, since this feed roller 50 is configured only to rotate when the welding wire 24 is in between the feel rollers 48 and 50 and a clamp forces the feed rollers 48 and 50 into engagement with one another and the welding wire 24.

It should be noted that, in certain embodiments, the shaped features that are detected by the VTO 90 may be features already present on an existing feed roller 50 (e.g., a feed roller 50 of an existing wire feeder 20 within which the roller rotation measurement system 66 may be retrofit, for example). In such an embodiment, the VTO 90 of the roller rotation measurement system 66 may be capable of detecting motion of a shaped feature already existing on a surface of the existing feed roller 50, such as a logo on an outer lateral surface of the feed roller 50, among other shaped features.

FIG. 4 illustrates a more representative view of the VTO 90 and its proximity to the shaped features 98 of the feed roller 50 during operation. The roller rotation measurement system 66 is mounted on an inside surface of the wire drive assembly housing 52 such that the inductor 96 of the VTO 90 faces outward toward the face of the feed roller 50 having the shaped features 98. Similarly, the shaped features 98 are formed into the side of the feed roller 50 that is facing the detection circuitry of the roller rotation measurement system 66. The roller rotation measurement system 66 may be mounted such that the inductor 96 is located at approximately the same radial distance from the centerline 100 of the feed roller 50 as the shaped features 98. That way, each time one of the shaped features 98 passes the inductor 96, the roller rotation measurement system 66 is able to detect the passing shaped feature 98.

Turning back to FIG. 3, the VTO 90 is a circuit that includes at least the inductor 96 and a capacitor 102. The inductor 96 and the capacitor 102 are driven by a voltage or current supplied to the VTO 90. For example, the PLL controller 92 may provide a voltage across the VTO 90, thereby urging current to oscillate within the VTO 90. Specifically, when a voltage is applied across the VTO 90, current may flow back and forth through the inductor 96, from one plate of the capacitor to the other. Current oscillates through the VTO 90 in this manner at an oscillating frequency.

The oscillating frequency may vary based on the proximity of the VTO 90 to the shaped features 98 of the feed roller 50. For example, during operation of the illustrated VTO 90, rotation of the feed roller 50 effectively modulates the inductance in the inductor coil 96. The shaped features 98 provide a variation in the mass of ferrous material (e.g., steel) that passes by the VTO 90. Therefore, as each shaped feature 98 passes the inductor 96, the shaped feature 98 alters the magnetic field of the inductor 96, thereby affecting the relative inductance of the inductor 96 in the VTO 90. This change in inductance through the inductor 96 generally changes the resonant frequency of the oscillation of current through the VTO 90.

As noted above, the PLL controller 92 is coupled to the VTO 90, and in some instances the PLL controller 92 provides a voltage (e.g., across points 104) to the VTO 90. When the VTO 90 is operating at a consistent oscillating frequency, the voltage supplied to the VTO 90 may be maintained at an approximately constant value. However, when the frequency of the VTO 90 slightly changes, the PLL controller 92 may send a correcting voltage to the VTO 90 to adjust the frequency back to the same oscillating frequency and phase as before. In other words, the correcting voltage constantly ensures that the frequency of the VTO 90 is maintained. To that end, the PLL controller 92 includes a circuit configured to compare a reference frequency (e.g., desired or normal VTO oscillating frequency) to the actual oscillating frequency of the VTO 90, to filter the signal, and to determine a correction voltage that can be sent to the VTO 90 to adjust the actual oscillating frequency back to the reference frequency. In this manner, the PLL controller 92 effectively locks the VTO 90 onto the desired oscillating frequency by adjusting the voltage applied to the VTO 90.

When the VTO 90 is placed under the control of the PLL controller 92 in the manner described above, the VTO tuning voltage (e.g., correction voltage) will mirror the motion of the shaped features 98 passing the inductor 96. That is, each time one of the shaped features 98 passes the inductor 96, the inductance of the VTO 90 changes, thereby changing the frequency of the VTO 90 away from the reference frequency. The PLL controller 92 then sends a correction signal to tune the VTO 90 as the shaped feature 98 passes the inductor 96.

The microcontroller 94 is communicatively coupled to the PLL controller 92, and may be configured to receive an indication of the voltage correction signal sent from the PLL controller 92 to the VTO 90 for tuning the VTO 90. The microcontroller 94 may then process the received waveform of the voltage correction signal to determine the approximate rate of rotation of the feed roller 50. That is, the microprocessor 94 may process the varying voltage sent to the VTO 90 in order to determine the rotational speed of the feed roller 50 with the shaped features 98. In the illustrated embodiment, for example, the feed roller 50 includes eight shaped features 98 (e.g., dimples). Accordingly, for every rotation of the feed roller 50, there will be eight artifacts in the correcting voltage signal sent from the PLL controller 92 to the VTO 90. Thus, the microprocessor 94 may determine the rotational speed of the feed roller 50 based on how much time passes between the artifacts in the voltage signal (e.g., since there is approximately 45 degrees between each pair of adjacent artifacts).

In addition, the microprocessor 94 may determine the linear wire feed speed of the wire feeder 20 based on the voltage correction signal received from the PLL controller 92. Specifically, if the effective radius of the feed roller 50 (from the centerline 100 to the point of contact between the welding wire 24 and the feed roller 50) is known, the processor 94 may transform the rotational speed of the feed roller 50 into the linear wire feed speed of the wire feeder 20. As illustrated, the microprocessor 94 may be in communication with the control circuitry 28 of the wire feeder 20, such as via a serial interface 106. Accordingly, the microprocessor 94 of the roller rotation measurement system 66 may provide a signal indicative of the linear wire feed speed to the control circuitry 28, thereby providing feedback for the control circuitry 28 that is controlling the motor drive circuit 60 of the wire feeder 20.

The disclosed roller rotation measurement system 66 utilizes relatively low power components compared to currently existing feed roller rotation measurement systems. The VTO 90, PLL controller 92, and microcontroller 94 are readily available components that use micro-currents, allowing for relatively long life production cycles. LEDs used in currently existing optical systems for detecting feed roller rotation have much higher power requirements than the components in the illustrated roller rotation measurement system 66. The disclosed roller rotation measurement system 66 is also more tolerant of dust and contamination within the wire feeder 20 than existing optical measurement systems, since the disclosed system does not need to have optical clarity to detect the shaped features 98 on the feed roller 50.

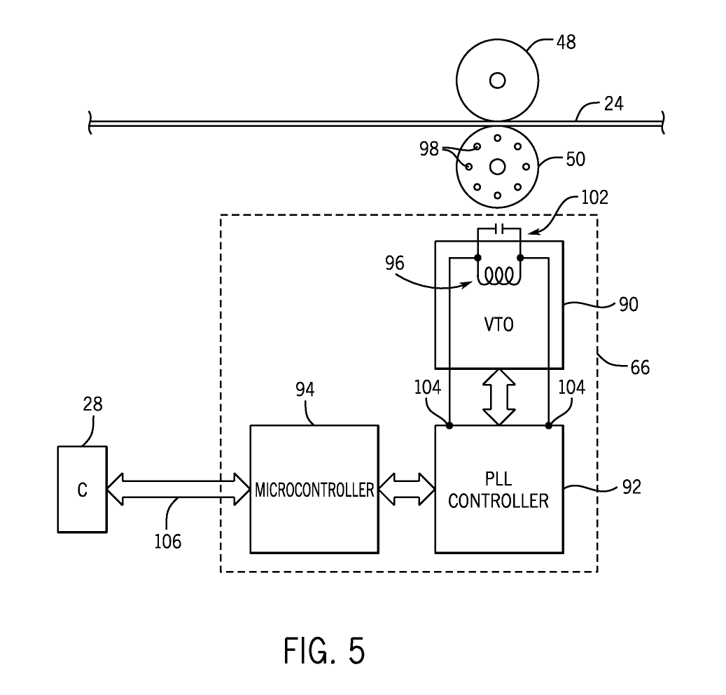

Another embodiment of the roller rotation measurement system 66 is illustrated in FIG. 5. In this embodiment, the shaped features 98 formed on the feed roller 50 may influence the capacitance of the capacitor 102 of the VTO 90. Altering the capacitance in this manner may change the oscillating frequency of the VTO 90, as before. Therefore, the same type of PLL controller 92 and microcontroller 94 may determine a rotational speed (and a linear wire feed speed) of the feed roller 50 based on the changes in frequency of the VTO 90 when the shaped features 98 pass by the capacitor 102.

In the illustrated embodiment, the capacitor 102 is placed in relatively close proximity to the feed roller 50, in order to detect the shaped features 98 as the feed roller 50 rotates, while the inductor 96 is disposed inside a portion of the VTO 90 that shields the inductor 90. That is, the illustrated inductor 96 of the VTO 90 is shielded from magnetic fields present within the wire feeder 20. If there are strong magnetic fields derived from weld current passing through the wire feeder 20, the VTO 90 may remain unaffected by these magnetic fields. In embodiments of the roller rotation measurement system 66 where the inductor 96 is exposed, as shown in FIG. 3, the capacitor 102 may be shielded. That way, whichever one of the capacitor 102 or the inductor 90 is closest to the feed roller 50 will be the only one that is affected by the shaped features 98, magnetic fields, and other disturbances within the wire feeder 20. In certain embodiments, it may be desirable for the capacitor 102 to be shielded and for the inductor 96 to be exposed and extending toward the feed roller 50, while in other embodiments it may be desirable to use an opposite arrangement. Different types of sensors, capacitive or inductive, used to determine when the shaped features 98 pass by the roller rotation measurement system 66 may work better for certain wire feeders 20 or certain welding applications.

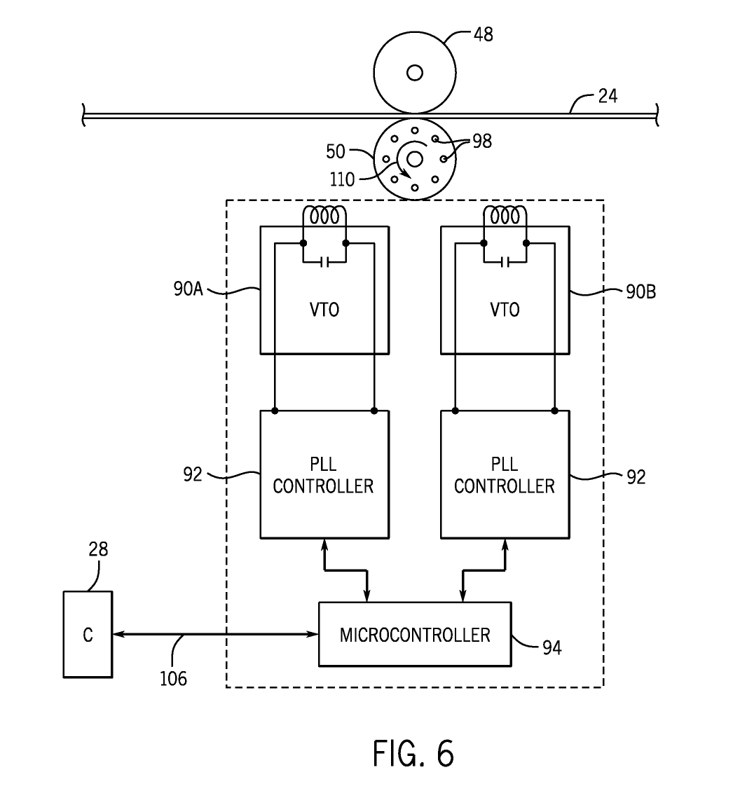

In certain embodiments, it may be desirable for the roller rotation measurement system 66 to determine the speed of rotation of the feed roller 50 and the direction of rotation of the feed roller 50. This may provide the control circuitry 28 of the wire feeder 20 with more accurate information relating to the velocity (direction and speed) of the welding wire 24 moving through the wire feeder 20. To that end, the roller rotation measurement system 66 may be configured for quadrature detection as described below. FIG. 6 illustrates an embodiment of the roller rotation measurement system 66 configured for this quadrature detection. The roller rotation measurement system 66 illustrated in FIG. 6 includes two VTOs 90 paired with respective PLL controllers 92 and used to detect one or more sets of shaped features 98.

As illustrated, the two VTOs 90 may be placed close together. That way, each shaped feature 98 of the feed roller 50 may pass one VTO 90 just before the other VTO 90. As described in detail above, each of the PLL controllers 92 may send a correcting voltage to tune the current of the corresponding VTO 90, and a signal indicative of each correcting voltage is sent to the microcontroller 94 as well. The microcontroller 94, upon comparing the signals from the two PLL controllers 92, may determine both the speed and direction of rotation of the feed roller 50. Specifically, the microcontroller 94 may detect the frequency of each correction voltage signal. These should be approximately the same since they are both indicative of the same feed roller rotation speed.

In addition, the microcontroller 94 may detect the phase offset of the two signals, in order to determine which one of the VTOs 90 was passed by the shaped features 98 just before the other one of the VTOs 90 as the feed roller 50 rotated. For example, if the microcontroller 94 determines that each shaped feature 98 passed the VTO 90A on the left just prior to passing the VTO 90B on the right, this indicates that the feed roller 50 is rotating in a counterclockwise direction 110. However, if the microcontroller determines that each shaped feature 98 passed the VTO 90B on the right just prior to passing the VTO 90A on the left, this indicates that the feed roller 50 is rotating in a clockwise direction.

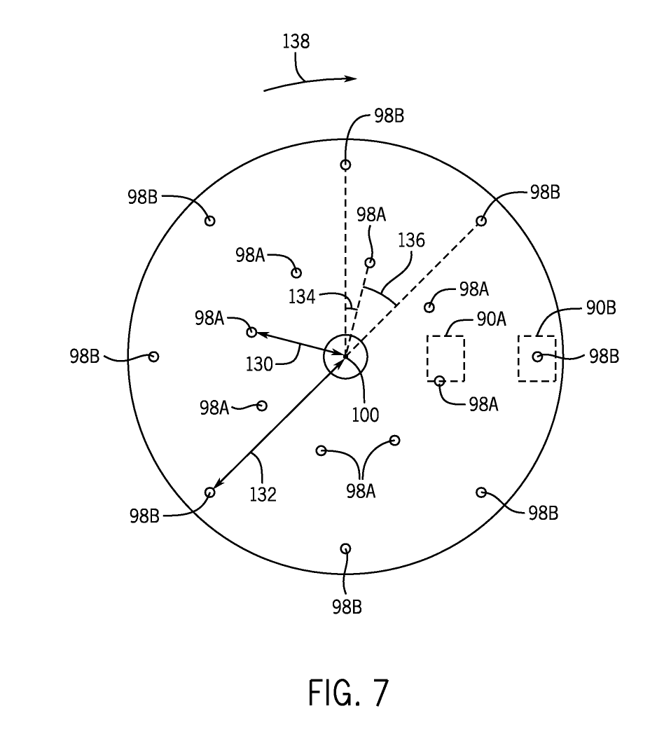

In other embodiments of the roller rotation measurement system 66, two sets of VTOs 90 and corresponding PLL controllers 92 may be used to detect the rotation of two sets of shaped features 98 formed into the feed roller 50. A schematic illustrating this type of system is provided in FIG. 7. This figure shows the feed roller 50 having two series of shaped features 98, each series being arranged about the feed roller 50 at a certain radius. For example, in the illustrated embodiment, a first series of shaped features 98A is arranged at a first radius 130 from the centerline 100. A second series of shaped features 98B is arranged at a second radius 132 from the centerline 100, this second radius 132 being greater than the first radius 130. The first VTO 90A may be disposed at a position proximate to the first radius 130 from the centerline 100 and the second VTO 90B may be disposed at a position proximate to the second radius 132 from the centerline 100.

In certain embodiments, the two VTOs 90A and 90B may be aligned with one another in a radial direction relative to the centerline 100 of the feed roller 50, while the two series of shaped features 98A and 98B are offset from each other by an angle. More specifically, the first series of shaped features 98A and the second series of shaped features 98B may be offset from each other by a first angle 134 in one direction and by a second angle 136 in the opposite direction. The first and second angles 134 and 136 are different from one another. That way, as the feed roller 50 rotates in a clockwise direction, for example, the phase offset between the shaped feature 98A passing the VTO 90A and the shaped feature 98B passing the VTO 90B will be determined by the first and second angles 134 and 136. The microcontroller 94 may determine, based on the voltage correction signals from the PLL controllers 92, that the feed roller 50 is rotating in the clockwise direction 138 based on the detected phase offset in the signals.

In other embodiments, the feed roller 50 may include the two series of shaped features 98A and 98B arranged such that they are radially aligned with each other relative to the centerline 100. In such embodiments, the VTOs 90A and 90B corresponding to each series of shaped features 98A and 98B may be offset by a particular angle relative to the centerline 100. This type of arrangement may allow for relatively easier manufacturing of the feed roller 50 since both series of shaped features 98 are in alignment. Any of the above described quadrature detection methods may be relatively less expensive, less affected by dust and contamination, and require lower power than existing mechanical and optical sensing systems used to detect the direction and speed of feed roller rotation.

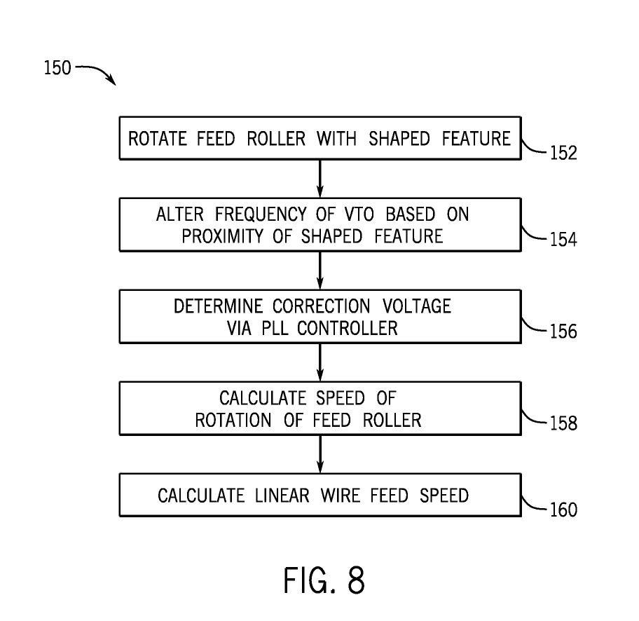

FIG. 8 is a process flow diagram of a method 150 for measuring a wire feed speed of the wire feeder 20 using the disclosed roller rotation measurement system 66. The method 150 includes rotating (block 152) the feed roller 50 having the shaped features 98 formed therein. The method 150 also includes altering (block 154) the frequency of the oscillations of current through the VTO 90 based on proximity of the shaped features 98 to the VTO 90. That is, when one of the shaped features 98 passes the VTO 90, the inductance or capacitance of the VTO 90 is altered, thereby altering the frequency of oscillation through the circuit. In addition, the method 150 includes determining (block 156) a correction voltage via the PLL controller 92 for adjusting the oscillating frequency of the VTO 90 back to a reference frequency. It will be appreciated that the adjustment of the oscillating frequency that is accomplished by the correction voltage occurs so fast that the oscilating frequency is effectively maintained at the reference frequency. Further, the method 150 includes calculating (block 158) a speed of rotation of the feed roller 50 based on the determined correction voltage via a processor (e.g., microprocessor 94). Further still, the method 150 includes calculating (block 160) a linear wire feed speed of the wire feeder 20 via the processor based on the rotational speed of the feed roller 50 and a known effective radius of the feed roller 50. In addition, as described herein, the calculated linear wire feed speed may be provided to the control circuitry 28 of the wire feeder 20 as feedback for controlling the motor drive circuit 60 of the wire feeder 20.

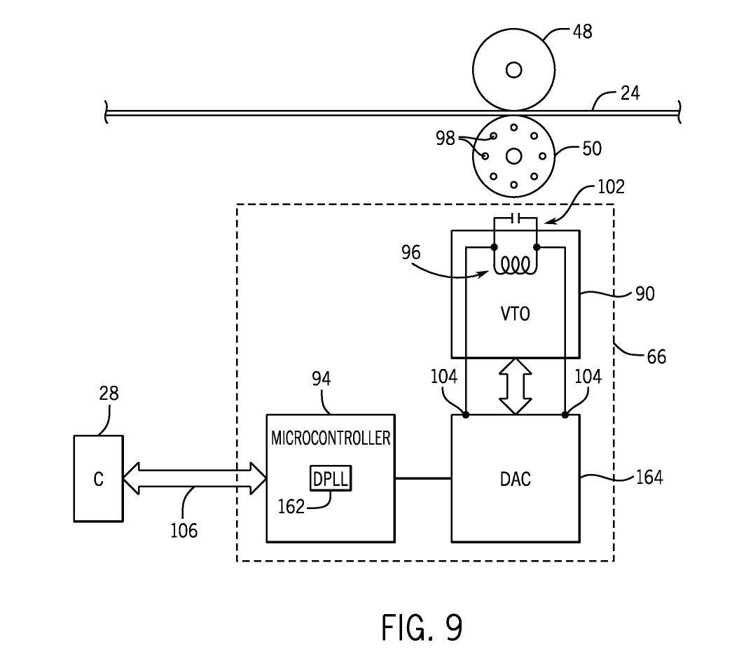

In the embodiments described herein, the PLL controllers 92 may be analog PLL controllers. In other words, the PLL controllers 92 are implemented in hardware. However, in other embodiments, the analog PLL controllers 92 described herein may be replaced with digital PLL (DPLL) controllers 162, which operate entirely within software executed on the microcontroller 94. FIG. 9 illustrates an embodiment of the roller rotation measurement system 66 incorporating a DPLL controller 162. In such an embodiment, the phase detector and the loop filter functionality described herein may be included as a software program operating on the microcontroller 94, which then uses a variable analog output to drive the VTO 90 (e.g., as in to achieve phase lock). As illustrated in FIG. 9, in certain embodiments, the analog output may be created using a digital-to-analog converter (DAC) 164 in conjunction with the microprocessor 94. In other embodiments, the analog output of the microcontroller 94 may be from a general purpose input/output (GPIO) pin that effectively operates as an oversampled pulse coded modulation (PCM) output, a special purpose output that uses pulse width modulation (PWM) to affect a variable DC voltage that can drive the VTO 90, and so forth.

In certain embodiments, the DPLL controller 162 may include an internal numerically controlled oscillator (NCO), a phase detector, and a loop filter, all operating as software on the microcontroller 94, which uses simple input/output structures (e.g., PWM, counter-timers, DACs, ADCs, and so forth) so as to not use voltage control, but is rather allowed to “free run” with nominal frequency control by virtue of the relationship between the inductance and capacitance of its resonator. As described herein, the motion of the feed roller 50 perturbs and slightly alters the reactive impedance of the resonant circuit in the VTO 90, which then attempts to drive the VTO 90 from chosen operating frequency of the VTO 90, and the microcontroller 94 samples the output of the VTO 90. The microcontroller 94 then, utilizing the DPLL 162 controller, drives the NCO of the DPLL controller 162 to a frequency to close the loop (e.g., achieve a phase lock condition). In this case, the NCO command sequence becomes the signature related to speed and acceleration of the feed roller 50.

In certain embodiments, the VTO 90 is perturbed by the shaped features of the feed roller 50 so as to alternate its operating frequency periodically as the feed roller 50 rotates, and the microcontroller 94 samples the oscillator output(s) and performs low-level digital signal processing (DSP) on the data. In certain embodiments, such processing includes fast Fourier transform (FFT) (to indicate frequency of rotation and acceleration of the feed roller 50) along with data signature analysis to look for other motion-induced anomalies.

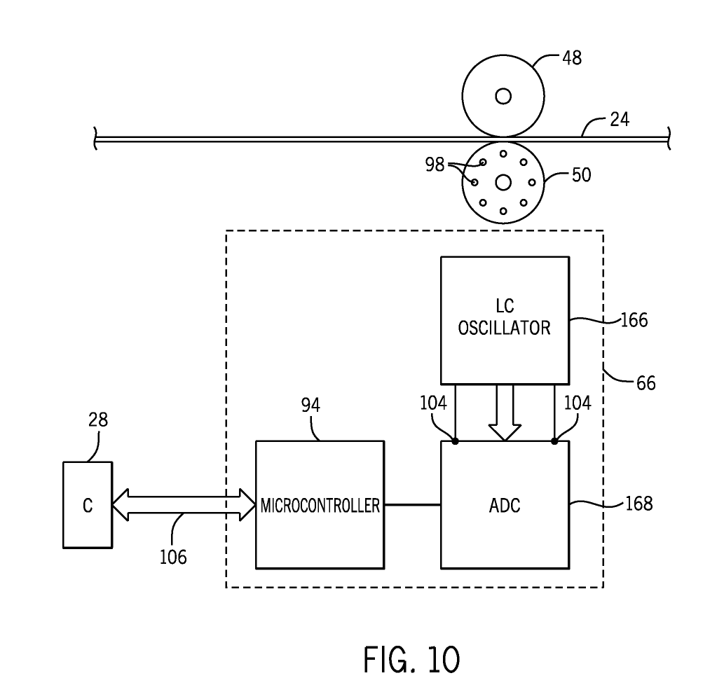

FIG. 10 illustrates another embodiment of the roller rotation measurement system 66. In the illustrated embodiment, an uncontrolled inductor-capacitor (LC) oscillator 166 is used instead of the VTO 90 described herein. In such an embodiment, the frequency of the LC oscillator 166 may be sampled, and the microcontroller 94 may perform both an FFT on the measured data, as well as digital pattern recognition analysis to determine both direction and speed of the feed roller 50. It is noted that, in such an embodiment, neither a PLL controller nor a DPLL controller is utilized.

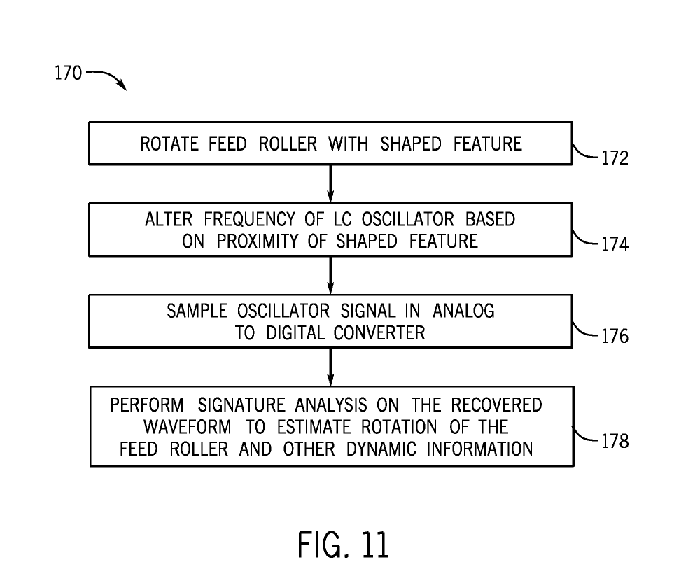

FIG. 11 is a process flow diagram of a method 170 for measuring a wire feed speed of the wire feeder 20 using the roller rotation measurement system 66 illustrated in FIG. 10. The method 170 includes rotating (block 172) the feed roller 50 having the shaped features 98 formed therein. The method 170 also includes altering (block 174) the frequency of the LC oscillator 166 based on proximity of the shaped features 98 to the LC oscillator 166. In addition, the method 170 includes sampling (block 176) an oscillator signal from the LC oscillator 166 (e.g., using an analog-to-digital converter (ADC) 168), and performing (block 178) signature analysis on the recovered waveform to estimate rotation of the feed roller 50 and other dynamic information. It will be appreciated that the microprocessor 94 may also close the loop with the LC oscillator 166 to, for example, achieve a phase lock condition.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. A feed roller rotation measurement system, comprising:
a voltage tuned oscillator (VTO) comprising a capacitor and an inductor coupled to each other, wherein the VTO is configured to be disposed adjacent a shaped feature formed in a surface of a feed roller of a wire feeder;
a phase locked loop (PLL) controller electrically coupled to the VTO and configured to determine and send a correction voltage to the VTO to maintain the VTO at a desired oscillating frequency; and
a processor coupled to the PLL controller and configured to receive a signal from the PLL controller indicative of the correction voltage and to calculate a speed of rotation of the feed roller based at least in part on the received signal.

2. The feed roller rotation measurement system of claim 1, wherein the shaped feature comprises a protuberance, a bump, a dimple, a divot, a small pocket, or a hole.

3. The feed roller rotation measurement system of claim 1, wherein the VTO is configured to be disposed such that the inductor is adjacent the shaped feature formed in the surface of the feed roller.

4. The feed roller rotation measurement system of claim 1, wherein the VTO is configured to be disposed such that the capacitor is adjacent the shaped feature formed in the surface of the feed roller.

5. The feed roller rotation measurement system of claim 1, wherein a frequency of a current flowing through the VTO changes in response to an inductance change of the inductor or a capacitance change of the capacitor.

6. The feed roller rotation measurement system of claim 1, wherein the VTO, the PLL controller, and the processor are disposed in a unit configured to be mounted to the wire feeder.

7. A wire feeder, comprising:
a feed roller configured to rotate with respect to a housing of the wire feeder, wherein the feed roller comprises a shaped feature formed into a surface of the feed roller;
a first frequency oscillator disposed adjacent the surface of the feed roller, wherein the first frequency oscillator comprises a capacitor and an inductor coupled to each other;
a controller electrically coupled to the first frequency oscillator and configured to determine and send a correction voltage to the first frequency oscillator to maintain the first frequency oscillator at a desired oscillating frequency; and
a processor coupled to the controller and configured to receive a signal from the controller indicative of the correction voltage and to calculate a speed of rotation of the feed roller based at least in part on the received signal.

8. The wire feeder of claim 7, wherein the first frequency oscillator, the controller, and the processor are disposed in a unit mounted to the housing.

9. The wire feeder of claim 7, wherein one of the inductor or the capacitor of the first frequency oscillator is disposed adjacent the feed roller while the other of the inductor or the capacitor is shielded from the feed roller.

10. The wire feeder of claim 7, wherein the shaped feature is configured to affect an inductance of the inductor or a capacitance of the capacitor when the shaped feature passes the first frequency oscillator.

11. The wire feeder of claim 7, comprising control circuitry coupled to the processor, wherein the control circuitry is configured to control a wire feed speed of the wire feeder based at least in part on feedback received from the processor.

12. The wire feeder of claim 7, wherein the feed roller comprises a first series of shaped features arranged on the surface of the feed roller a first radial distance away from a central axis of the feed roller, wherein the first frequency oscillator is disposed at a position proximate to the first radial distance from the central axis of the feed roller.

13. The wire feeder of claim 12, wherein the feed roller comprises a second series of shaped features arranged on the surface of the feed roller a second radial distance away from the central axis of the feed roller, wherein the second radial distance is different from the first radial distance, and wherein the wire feeder comprises a second frequency oscillator disposed adjacent the feed roller at a position proximate to the second radial distance from the central axis of the feed roller.

14. The wire feeder of claim 13, wherein the controller is coupled to both the first frequency oscillator and the second frequency oscillator, and wherein the processor is configured to calculate a speed of rotation and a direction of rotation of the feed roller based at least in part on signals indicative of correction voltages sent to the first and second frequency oscillators.

15. The wire feeder of claim 13, wherein the first and second series of shaped features are angularly offset from each other with respect to the central axis of the feed roller.

16. The wire feeder of claim 7, wherein the controller is an analog phase locked loop (PLL) controller.

17. The wire feeder of claim 7, wherein the controller is a digital phase locked loop (DPLL) controller.

18. The wire feeder of claim 17, wherein the DPLL controller comprises a numerically controlled oscillator, a phase detector, and a loop filter, each of which are operable as software executable by a processor of the controller.

19. The wire feeder of claim 7, wherein the first frequency oscillator is a voltage tuned oscillator (VTO).

20. The wire feeder of claim 7, wherein the first frequency oscillator is an uncontrolled inductor-capacitor (LC) oscillator.

21. A method, comprising:
rotating a feed roller of a wire feeder with respect to a wire feeder housing to move a welding wire through the wire feeder, wherein the feed roller comprises at least one shaped feature formed into a surface of the feed roller;
maintaining a frequency of a voltage tuned oscillator (VTO) disposed adjacent the feed roller based on a correction voltage determined by a phase locked loop (PLL) controller coupled to the VTO based at least in part on motion of the at least one shaped feature of the feed roller with respect to the VTO; and
calculating a speed of rotation of the feed roller based at least in part on the correction voltage via a processor coupled to the PLL controller.

22. The method of claim 21, comprising calculating a linear wire feed speed of the wire feeder based at least in part on the calculated speed of rotation of the feed roller and a radius of the feed roller.

23. The method of claim 21, wherein the VTO comprises an inductor disposed adjacent the feed roller, and wherein maintaining the frequency of the VTO comprises altering the correction voltage to offset a change in an inductance of the inductor.

24. The method of claim 21, wherein the VTO comprises a capacitor disposed adjacent the feed roller, and wherein maintaining the frequency of the VTO comprises altering the correction voltage to offset a change in a capacitance of the capacitor.
